(19) United States
(12) Patent Application Publication
(10) Pub. No.: US 2022/0108434 A1
(43) Pub. Date: Apr. 7, 2022

(54) DEEP LEARNING FOR DEFECT DETECTION IN HIGH-RELIABILITY COMPONENTS

(71) Applicant: National Technology & Engineering Solutions of Sandia, LLC, Albuquerque, NM (US)

(72) Inventors: Emily Donahue, Albuquerque, NM (US); Tu-Thach Quach, Albuquerque, NM (US); Christian Turner, Albuquerque, NM (US); Kevin M. Potter, ALbuquerque, NM (US)

(21) Appl. No.: 17/166,166

(22) Filed: Feb. 3, 2021

Related U.S. Application Data
(60) Provisional application No. 63/088,746, filed on Oct. 7, 2020.

(51) Int. Cl. G06T 7/00; G06K 9/62; G06N 3/08; G06N 3/04

(52) U.S. Cl. CPC G06T 7/0002; G06K 9/6202; G06N 3/084; G06T 2207/10081; G06T 2207/20084; G06T 2207/20081; G06N 3/0454

(57) ABSTRACT

A computer-implement method for training a neural network to detect defects is provided. The method comprises encoding, by an encoder, a real image of an object to produce a first compressed image as a first vector in a latent space, wherein the real image is free of defects. A decoder then generates a reconstructed image from the first vector in the latent space, wherein the reconstructed image is a closest non-anomalous reconstruction of the real image. A discriminator compares the real image and the reconstructed image and determines which image is the real image and which image is the reconstructed image. The encoder also encodes the reconstructed image to produce a second compressed image as a second vector in the latent space.

### CROSS-REFERENCE TO RELATED APPLICATION

This application claims the benefit of U.S. Provisional Application No. 63/088,746, filed Oct. 7, 2020, which is hereby incorporated by reference in its entirety.

### STATEMENT OF GOVERNMENT INTEREST

This invention was made with United States Government support under Contract No. DE-NA0003525 between National Technology & Engineering Solutions of Sandia, LLC and the United States Department of Energy. The United States Government has certain rights in this invention.

### BACKGROUND

### 1. Field

The disclosure relates generally to defect detection, and more specifically to automatically identifying defects or flaws that can be potentially used for quality assurance of two-dimensional and three-dimensional objects.

### 2. Description of the Related Art

Defect detection is an invaluable tool for the quality assurance in manufacturing process. There are number of ways to detect different types of defects, but it is usually hard to find the balance between maximizing yield and minimizing the number of defective parts that makes it through the quality control process. Traditionally, the detection of defects is achieved by visual-based approaches. For example, human inspection or automate defect detection.

Automatic detection of defects in as-built parts is a challenging task due to the large number of potential manufacturing flaws that can occur. X-Ray computed tomography (CT) can produce high-quality images of the parts in a non-destructive manner. The images, however, are grayscale valued, often have artifacts and noise, and require expert interpretation to spot flaws. For anomaly detection to be reproducible and cost effective, an automated method is needed to and potential defects. Traditional supervised machine learning techniques fail in the high reliability parts regime due to large class imbalance: there are often many more examples of well-built parts than there are defective parts. This, coupled with the time expense of obtaining labeled data, motivates research into unsupervised techniques.

Therefore, it would be desirable to have a method and apparatus that take into account at least some of the issues discussed above, as well as other possible issues.

### SUMMARY

An illustrative embodiment provides a computer-implement method for training a neural network to detect defects. The method comprises encoding, by an encoder, a real image of an object to produce a first compressed image as a first vector in a latent space, wherein the real image is free of defects. A decoder then generates a reconstructed image from the first vector in the latent space, wherein the reconstructed image is a closest non-anomalous reconstruction of the real image. A discriminator compares the real image and the reconstructed image and determines which image is the real image and which image is the reconstructed image. The encoder also encodes the reconstructed image to produce a second compressed image as a second vector in the latent space.

Another illustrative embodiment provides a system for training a neural network to detect defects. The system comprises a storage device configured to store program instructions and one or more processors operably connected to the storage device and configured to execute the program instructions to cause the system to: encode, by an encoder, a real image of an object to produce a first compressed image as a first vector in a latent space, wherein the real image is free of defects; generate, by a decoder, a reconstructed image from the first vector in the latent space, wherein the reconstructed image is a closest non-anomalous reconstruction of the real image; compare, by a discriminator, the real image and the reconstructed image; determining, by the discriminator, which image is the real image and which image is the reconstructed image; and encode, by the encoder, the reconstructed image to produce a second compressed image as a second vector in the latent space.

The features and functions can be achieved independently in various examples of the present disclosure or may be combined in yet other examples in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 depicts a block diagram of an image reconstruction training system in accordance with an illustrative embodiment;

FIG. 2 depicts a diagram illustrating a node in a neural network with which illustrative embodiments can be implemented;

FIG. 3 depicts a diagram illustrating a convolutional neural network with which the illustrative embodiments can be implemented;

FIG. 4 depicts an architecture for a generative adversarial network in accordance with an illustrative embodiment;

FIG. 5 depicts a flowchart for training the image reconstruction system in accordance with illustrative embodiments;

FIG. 6 depicts a flowchart for back propagating a loss function in accordance with illustrative embodiments; and

FIG. 7 is a diagram of a data processing system depicted in accordance with an illustrative embodiment.

### DETAILED DESCRIPTION

The illustrative embodiments recognize and take into account one or more different considerations. For example, the illustrative embodiments recognize and take into account that automatic detection of defects in as-built parts is a challenging task due to the large number of potential manufacturing flaws that can occur.

The illustrating embodiments also recognize and take into account that X-Ray computed tomography (CT) scanning is an invaluable tool for quality assurance in manufacturing, but a generalized method of searching CT scans for anomalies in real-world data does not yet exist. This state of affairs exists largely due to the fact that the imaging process produces artifacts from reconstruction. To create a CT scan, an object is irradiated with X-Rays to capture an image and slowly rotated about a central axis to obtain images from many angles. These X-Ray images are then mathematically reconstructed to obtain a 3-D representation of the imaged object, but the reconstruction process has a fundamental trade-off between spatial resolution and image noise. Additionally, materials with high atomic numbers can create “streaking” artifacts, which are caused by scattering from the incident X-Rays. For these reasons, simple heuristics (e.g., using a threshold to determine material boundaries) often fail for X-Ray CT data. This makes segmentation and downstream tasks, such as anomaly detection, all the more difficult.

The illustrating embodiments also recognize and take into account that available analysis software can perform contrastive signal processing to make defects more obvious, but humans must determine which features are outliers. This requirement of human input makes applying this to all but the most critical components impractical as well as unreproducible. Therefore, traditional supervised machine learning techniques fail in the high reliability parts regime due to large class imbalance, e.g., there are many more examples of well-built parts than the defective parts in the training set.

The illustrating embodiments also recognize and take into account that visualizing 3-D data is complex. For example, image labeling would be extremely difficult if a thin crack does not align with an axis and recognizing it would require a person analyzing the data to label it manually. The illustrating embodiments also recognize and take into account that traditional Generative Neural Network training method requires altering the forward pass when inverting the information gradient from the discriminator during training steps. Those training methods can be costly on both memory and parameter counts.

The illustrative embodiments provide a method of training defect detection system by creating a hybrid between Generative Adversarial Network (GAN) and an autoencoder. This method avoids the need to train the generator/decoder networks and the discriminator in an alternating fashion by involving a single forward and backpropagation pass through the entire network. The illustrative embodiments also provide looping back the reconstructed image to the latent space with a second encoding process.

The network of the illustrative embodiments learns an encoding function to a latent space of defect-free components and a decoding function to reconstruct the original image. The training data is restricted to defect-free components to ensure the encode-decode operation cannot learn to reproduce defects well. The difference between the reconstruction and the original image highlights anomalies that can be used for defect detection. In CT images, the illustrative embodiments successfully identify cracks, voids, and high z inclusions. Beyond CT, the illustrative embodiments operate successfully with little to no modifications on a variety of common 2-D defect datasets both in color and grayscale.

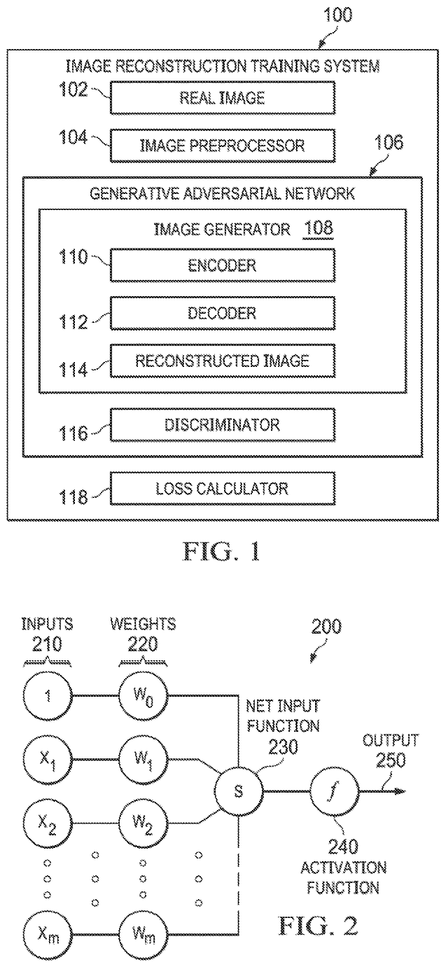

FIG. 1 depicts a block diagram of an image reconstruction training system in accordance with an illustrative embodiment. Image reconstruction training system 100 might comprise an image preprocessor 104 and generative adversarial network (GAN) 106.

Image preprocessor 104 receives a real image 102 as input. Real image 102 might be a user-provided input image depicting at least one object of interests. For example, the real image 102 might be a two-dimensional image, a three-dimensional image, a colored image, or a grayscale image. In the illustrative embodiments, real image 102 is free of defects.

Image preprocessor 104 performs data processing on real image 102 before the image is passed to GAN 106. Preprocessing might comprise removal of artifacts from real image 102 such as edge effects, e.g., white borders around the image.

Image preprocessor 104 then passes the image 102 to GAN 106 for training. GAN 106 comprises an image generator 108, which includes encoder 110 and decoder 112. Image generator 108 receives the input image 102 from the image processor 104 and outputs a reconstructed image using a machine learning model.

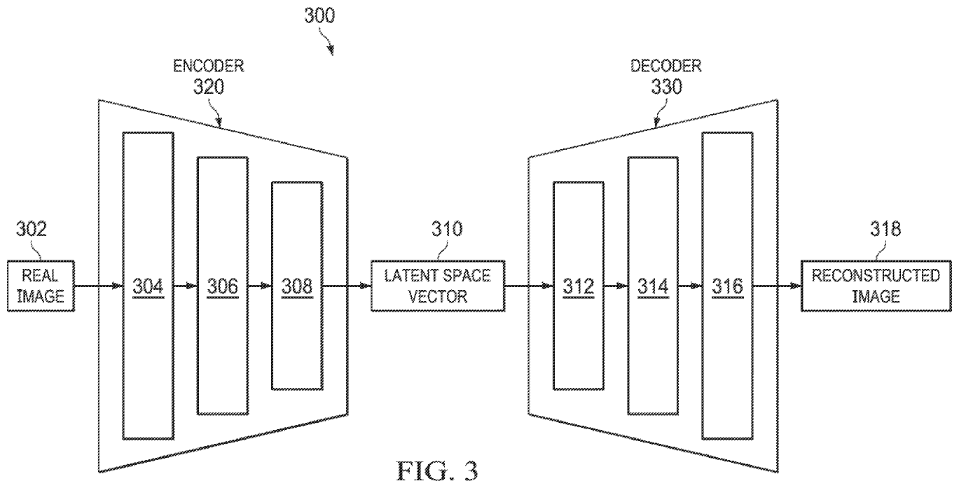

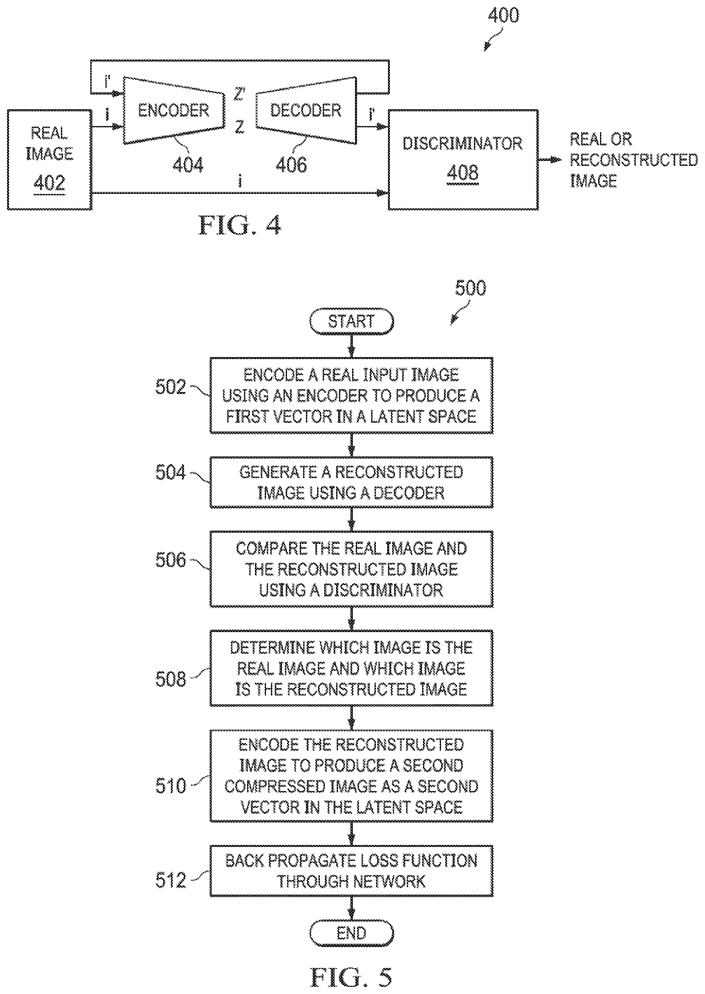

In the illustrated example, encoder 110 transforms the post-processed real image 102 into a reduced-dimensionality variable set and generates a vector of latent variable values in a latent space using an encoding function (see FIGS. 3 and 4). Decoder 112 then reconstructs the image from the latent variable values using a decoding function and outputs the reconstructed image 114 as the product of image generator 108.

The discriminator 116 receives both the real image 102 and the reconstructed image 114 generated from image generator 108 to determine which of the received images is real and which is reconstructed. The discriminator 116 might further compare real image 102 and the reconstructed image using a machine learning model, for example, a classifier neural network.

Image reconstruction training system 100 might also comprise loss calculator 118 to calculate a loss or difference of an individual image or a loss/difference between two images. In illustrative embodiments, loss calculator 118 might also calculate the loss of individual latent variable values in the latent space and the loss between at least two latent variable values in the latent space. Loss calculator 118 might compute the loss/difference using a predefined loss function to calculate the mean square error between images or latent variable values. Loss calculator 118 returns an updated loss function including weighted loss terms that is back propagated through decoder 112 and encoder 110 (explained in more detail below).

Image reconstruction training system 100 can support either a fully convolutional architecture or a fully connected layer at the chokepoint (see FIG. 3). A fully convolutional network performs well for all kinds of image data, especially, CT data, which has higher portion of non-anomalous data. In this illustrative embodiment, all results for two-dimensional images can be generated using a fully connected layer at the narrowest point of the network.

Image reconstruction training system 100 can be implemented in software, hardware, firmware or a combination thereof. When software is used, the operations performed by Image reconstruction training system 100 can be implemented in program code configured to run on hardware, such as a processor unit. When firmware is used, the operations performed by Image reconstruction training system 100 can be implemented in program code and data and stored in persistent memory to run on a processor unit. When hardware is employed, the hardware might include circuits that operate to perform the operations in Image reconstruction training system 102.

In the illustrative examples, the hardware might take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

As used herein a processor is comprised of hardware circuits such as those on an integrated circuit that respond and process instructions and program code that operate a computer. When a number of processors execute instructions for a process, the number of processors is one or more processors can be on the same computer or on different computers. In other words, the process can be distributed between processors on the same or different computers in computer system. Further, the number of processors can be of the same type or different type of processors. For example, a number of processors can be selected from at least one of a single core processor, a dual-core processor, a multi-processor core, a general-purpose central processing unit (CPU), a graphics processing unit (GPU), a digital signal processor (DSP), or some other type or processor.

These components can be located in a computer system, which is a physical hardware system and includes one or more data processing systems. When more than one data processing system is present in the computer system, those data processing systems are in communication with each other using a communications medium. The communications medium can be a network. The data processing systems can be selected from at least one of a computer, a server computer, a tablet computer, or some other suitable data processing system.

Supervised machine learning comprises providing the machine with training data and the correct output value of the data. During supervised learning the values for the output are provided along with the training data (labeled dataset) for the model building process. The algorithm, through trial and error, deciphers the patterns that exist between the input training data and the known output values to create a model that can reproduce the same underlying rules with new data. Examples of supervised learning algorithms include regression analysis, decision trees, k-nearest neighbors, neural networks, and support vector machines.

If unsupervised learning is used, not all of the variables and data patterns are labeled, forcing the machine to discover hidden patterns and create labels on its own through the use of unsupervised learning algorithms. Unsupervised learning has the advantage of discovering patterns in the data with no need for labeled datasets. Examples of algorithms used in unsupervised machine learning include k-means clustering, association analysis, and descending clustering.

FIG. 2 depicts a diagram illustrating a node in a neural network with which illustrative embodiments can be implemented. Node 200 combines multiple inputs 210 from other nodes. Each input 210 is multiplied by a respective weight 220 that either amplifies or dampens that input, thereby assigning significance to each input for the task the algorithm is trying to learn. The weighted inputs are collected by a net input function 230 and then passed through an activation function 240 to determine the output 250. The connections between nodes are called edges. The respective weights of nodes and edges might change as learning proceeds, increasing, or decreasing the weight of the respective signals at an edge. A node might only send a signal if the aggregate input signal exceeds a predefined threshold. Pairing adjustable weights with input features is how significance is assigned to those features with regard to how the network classifies and clusters input data.

Neural networks are often aggregated into layers, with different layers performing different kinds of transformations on their respective inputs. A node layer is a row of nodes that turn on or off as input is fed through the network. Signals travel from the first (input) layer to the last (output) layer, passing through any layers in between. Each layer's output acts as the next layer's input. Neural network layers can be stacked to create deep networks. After training one neural net, the activities of its hidden nodes can be used as inputs for a higher level, thereby allowing stacking of neural network layers. Such stacking makes it possible to efficiently train several layers of hidden nodes. Examples of stacked networks include deep belief networks (DBN), recurrent neural networks (RNN), and convolutional neural networks (CNN).

FIG. 3 depicts a diagram illustrating a convolutional neural network with which the illustrative embodiments can be implemented. CNN 300 might be an example of image generator 108 shown in FIG. 1 and comprises an encoder 320 and decoder 330. Encoder 320 comprises a number of sequential layers 304, 306, and 308, each layer comprising a number of nodes, such as node 200 shown in FIG. 2. Similarly, decoder 330 comprises a number of sequential layers 312, 314, and 316. Each encoder layer has a corresponding decoder layer.

The input comprises pixels/voxels representing a real image 302. The pixels/voxels are encoded into a lower dimensional representation by sequential encoder layers 304-308 comprising encoder 320, generating a latent space vector MO for the real image 302. The successive layers 312-216 comprising the decoder 330 then decode latent space vector 310 to generate reconstructed image 318.

Each decoding layer uses as its input the previous decoding layer's output. For example, the input to decoding layer 314 comprises the output from decoding layer 312.

Each of the layers 304-308 in the encoder 320 increases the level of abstraction or compression while each of the layers 312-316 in the decoder 330 decreases the level of abstraction.

FIG. 4 depicts an architecture for a generative adversarial network (GAN) in accordance with an illustrative embodiment. GAN 400 might be an example of GAN 106 shown in FIG. 1 and employ a convolutional neural network such as CNN 300 shown in FIG. 3.

Real image 402 (represented as i) is fed into both encoder 404 and discriminator 408. Encoder 404 produces a vector Z representing real image i 402 in the latent space. Decoder 406 then generates a reconstructed image i′ from vector Z. The reconstructed image i′ is then fed into discriminator 408 as well as looped back into encoder 404.

Discriminator 408 compares the real image i to the reconstructed image i′ and tries to determine which is which. Because both a real image i and a generated image i′ are available in each training step, the illustrative embodiments avoid the need to train the encoder 404/decoder 406 networks and the discriminator 408 in an alternating fashion, as in the traditional GAN training method, by inverting the gradient from the discriminator without altering the forward pass. Therefore, the encoder 404/decoder 406 (with one input: the real image i) and the discriminator 408 (with two inputs: the real image i and the reconstructed image i′) can be trained with a single forward and backpropagation pass through the entire network. The model contains support for multiple hyperparameters, allowing it to work for both 2-D and 3-D images, variable downsampling steps, and options for both fully convolutional and fully connected chokepoints.

Looping the reconstructed image i′ back through encoder 404 produces a second vector Z′ in the latent space, which is compared to the first vector Z in an additional loss term in constructing the loss function for the model. Encoding the reconstructed image i′ provides the encoder 404 more direct gradient information. In the absence of the second encoding reconstruction loss, the encoder parameters can only be informed by gradients that have passed through the decoder 406 (i.e. vanishing gradient problem).

The loss function for the model of the illustrative embodiments can be expressed as:

L=w_{image}L_{image}+wₗₐₜₑₙₜLₗₐₜₑₙₜ+w_{fake}L_{fake}+wᵣₑₐₗLᵣₑₐₗ

where w is a weighting term for each loss term. L_{image} is the mean squared error (MSE) for image reconstruction (reconstructing i′ from i). Lₗₐₜₑₙₜ is the MSE for image latent space reconstruction (reconstructing Z′ from Z). L_{fake} is the discriminative loss for the reconstructed image (i Lᵣₑₐₗ is the discriminative loss for the original image (i).

The illustrative embodiments train the deep learning model with defect-free example images (i.e. real image 402) so that the model will learn to output image from the anomaly-free domain. Subsequently, when present a test image as input, the model will output the closest non-anomalous image it can. The different between this non-anomalous prediction (i.e. reconstruction) and the input image will highlight the location of any potential anomalies.

To turn the continuous difference in reconstruction into a binary, anomalous/anomaly-free determination, the illustrative embodiments employ the common techniques of plotting the Receiver Operator Curve (ROC) and the Precision Recall (PR) curve. As a metric, the illustrative embodiments take the total area under each curve, called AUROC and AUPR respectively. For both these metrics, higher values are better with a value of 1.0 indicating perfect separation with no false positives or negatives.

Since anomaly labels often require less precision to be useful for applications such as part rejection, the illustrative embodiments plot curves against a variety of pooling sizes in addition to plotting per pixel curves. Each pixel is evaluated for each threshold as anomalous or non-anomalous. Then, max pool clusters of p×p are created for both the binary prediction and the label (i.e. if any part is anomalous, the cluster as a whole is considered anomalous). This provides a way to see how well the model does when exact anomaly localization is relaxed to varying scales.

FIG. 5 depicts a flowchart for training the image reconstruction system in accordance with illustrative embodiments. Process 500 might be implemented in hardware, software, or both. When implemented in software, the process can take the form of program code that is run by one of more processor units located in one or more hardware devices in one or more computer systems. Process 500 might be implemented in image reconstruction training system 102 shown in FIG. 1 using architecture 400 shown in FIG. 4.

Process 500 begins by encoding a real image using an encoder to produce a first vector in a latent space (step 502). The real image is free of defects. The encoder transforms the real image into a reduced dimensionality variable set and generates a vector of latent variable values in the latent space using a predefined encoding function. The function is set by the architecture, and the parameters defining the function's behavior are learned. The encoder might include multiple layers of convolutions. The output latent variable space might have lower dimensionality than the input space, and the vector of latent variable values might be considered as a compressed representation of the real image. In this illustrative example, the real image might depict at least one object of interests in color or grayscale. The real image might be a two-dimensional image or a three-dimensional image.

A decoder then generates a reconstructed image from the first vector in the latent space, wherein the reconstructed image is a closest non-anomalous reconstruction of the real image (step 504). The decoder is a learned function. The decoder might include multiple layers of deconvolutions to regenerate the image. There are least as many convolutions as deconvolutions. The image information in each convolution layer of the encoder might be fed to a corresponding deconvolution layers of the decoder to reconstruct the image from the vector of latent variable values.

The encoder and decoder might have any desired number of layers depending on the complexity of images being processed. For example, a three-layer design might be used for processing a simple image of one object that has only one color, whereas a six-layer architecture might be used for processing a complicated image of multiple objects that has multiple colors. Each lower layer receives input from the adjacent higher layer. Additional layers can augment the level of abstraction in the representation of the complicated image data.

The real image and the reconstructed image are compared by a discriminator using a discriminating function (step 506). The discriminator is a classifying function that classifies the input images and determines which received image is the real image and which image is the reconstructed image (step 508). The discriminator is a classifier configured to distinguish real image data from the reconstructed image data.

Process 500 might include a loss calculator for calculating the loss of an individual image or the difference between at least two images using a predefined loss function. The loss calculator returns an updated loss function that might include weighted loss term of every image it processed. For example, the weighted loss of the real image, the weighted loss of the reconstructed image, or weighted loss of the comparison between the real image and reconstructed image. In an illustrative embodiment, the loss/difference of images might be computed by calculating the MSE of image reconstruction (between real image and reconstructed image) and discriminative loss for the original image and the reconstructed image.

The encoder also encodes the reconstructed image to produce a second compressed image as a second vector in the latent space (step 510). The second encoding process compresses the reconstructed image to produce a second vector of latent variable values. The loss calculator might also calculate the loss/difference between at least two vectors of latent variable values in the latent space. The loss calculator computes the weighted loss of latent space reconstruction, which is the difference between the vector of latent variable values from encoding the real image and the vector of latent variable values from encoding the reconstructed image. The loss calculator combines all weighted loss and output an updated loss function, which might include the weighted loss of the real image, the weighted loss of the reconstructed image, the weighted loss of latent space reconstruction and the weighted loss of image reconstruction.

The loss function is then back propagated through the network from the discriminator to the decoder and the encoder (step 512). Process 500 then ends.

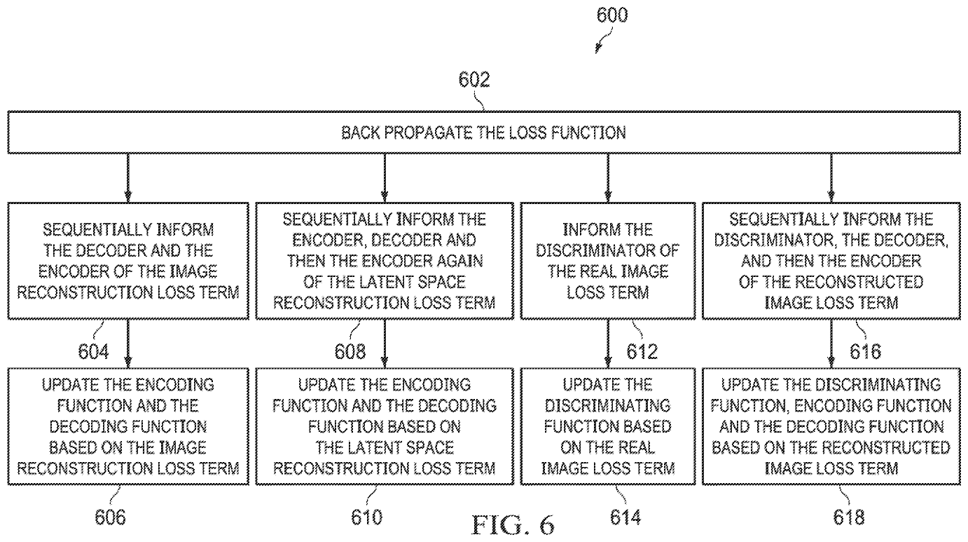

FIG. 6 depicts a flowchart for back propagating a loss function in accordance with illustrative embodiments. Process 600 is a more detailed example of step 512 in FIG. 5.

Process 600 begins by back propagating the updated loss function outputted by loss calculator to inform the discriminator, encoder, and decoder (step 602). Each weighted loss term goes through different routes to sequentially inform the component by inverting the gradient from the discriminator so that the training only involves a single forward and backpropagation pass through the entire network.

The weighted loss term for image reconstruction (i.e. w_{image}L_{image}) sequentially informs the decoder and the encoder in generative adversarial network (step 604). During back propagation, the decoding function and the encoding function are trained and updated based on the weighted loss of image reconstruction (step 606).

The weighted loss for latent space reconstruction (i.e. wₗₐₜₑₙₜLₗₐₜₑₙₜ) sequentially informs the encoder, decoder and then the encoder again in generative adversarial network (step 608). During back propagation, the decoding function and the encoding function are trained and updated based on the weighted loss of latent space reconstruction (step 610).

The weighted loss of real image (i.e. wᵣₑₐₗLᵣₑₐₗ) only informs the discriminator in generative adversarial network (step 612). During back propagation, the discriminating function is trained and updated based on the weighted loss of real image (step 614).

The weighted loss of reconstructed image (i.e. w_{fake}L_{fake}) sequentially informs the discriminator, the decoder, and then the encoder in generative adversarial network (step 616). During back propagation, the discriminating function, decoding function and the encoding function are trained and updated based on the weighted loss of reconstructed image (step 618). Process 600 then ends.

The information from the loss calculator is back propagated to the encoder and decoder for these components to update their model parameters to generate image data that perform better in fooling the discriminator. During the training phase, the discriminator is also updated from the weighted loss from the loss function in order to get better at distinguishing the real and generated images. At the end of training, the encoder and decoder are able to reconstruct image that is indistinguishable by the discriminator from the real image.

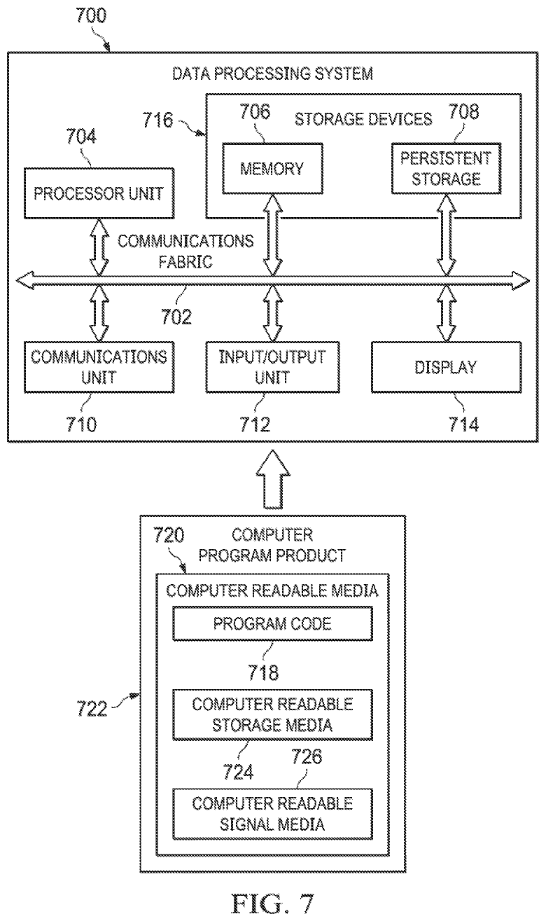

Turning now to FIG. 7, an illustration of a block diagram of a data processing system is depicted in accordance with an illustrative embodiment. Data processing system 700 may be used to implement image reconstruction training system 100 in FIG. 1. In this illustrative example, data processing system 700 includes communications framework 702, which provides communications between processor unit 704, memory 706, persistent storage 708, communications unit 710, input/output unit 712, and display 714. In this example, communications framework 702 may take the form of a bus system.

Processor unit 704 serves to execute instructions for software that may be loaded into memory 706. Processor unit 704 may be a number of processors, a multi-processor core, or some other type of processor, depending on the particular implementation. In an embodiment, processor unit 704 comprises one or more conventional general-purpose central processing units (CPUs). In an alternate embodiment, processor unit 704 comprises one or more graphical processing units (GPUs).

Memory 706 and persistent storage 708 are examples of storage devices 716. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 716 may also be referred to as computer-readable storage devices in these illustrative examples. Memory 716, in these examples, may be, for example, a random access memory or any other suitable volatile or non-volatile storage device. Persistent storage 708 may take various forms, depending on the particular implementation.

For example, persistent storage 708 may contain one or more components or devices. For example, persistent storage 708 may be a hard drive, a flash memory, a rewritable optical disk, a rewritable magnetic tape, or some combination of the above. The media used by persistent storage 708 also may be removable. For example, a removable hard drive may be used for persistent storage 708. Communications unit 710, in these illustrative examples, provides for communications with other data processing systems or devices. In these illustrative examples, communications unit 710 is a network interface card.

Input/output unit 712 allows for input and output of data with other devices that may be connected to data processing system 700. For example, input/output unit 712 may provide a connection for user input through at least one of a keyboard, a mouse, or some other suitable input device. Further, input/output unit 712 may send output to a printer. Display 714 provides a mechanism to display information to a user.

Instructions for at least one of the operating system, applications, or programs may be located in storage devices 716, which are in communication with processor unit 704 through communications framework 702. The processes of the different embodiments may be performed by processor unit 704 using computer-implemented instructions, which may be located in a memory, such as memory 706.

These instructions are referred to as program code, computer-usable program code, or computer-readable program code that may be read and executed by a processor in processor unit 704. The program code in the different embodiments may be embodied on different physical or computer-readable storage media, such as memory 706 or persistent storage 708.

Program code 718 is located in a functional form on computer-readable media 720 that is selectively removable and may be loaded onto or transferred to data processing system 700 for execution by processor unit 704. Program code 718 and computer-readable media 720 form computer program product 722 in these illustrative examples. In one example, computer-readable media 720 may be computer-readable storage media 724 or computer-readable signal media 726.

In these illustrative examples, computer-readable storage media 724 is a physical or tangible storage device used to store program code 718 rather than a medium that propagates or transmits program code 718. Computer readable storage media 724, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program code 718 may be transferred to data processing system 700 using computer-readable signal media 726. Computer-readable signal media 726 may be, for example, a propagated data signal containing program code 718. For example, computer-readable signal media 726 may be at least one of an electromagnetic signal, an optical signal, or any other suitable type of signal. These signals may be transmitted over at least one of communications links, such as wireless communications links, optical fiber cable, coaxial cable, a wire, or any other suitable type of communications link.

The different components illustrated for data processing system 700 are not meant to provide architectural limitations to the manner in which different embodiments may be implemented. The different illustrative embodiments may be implemented in a data processing system including components in addition to or in place of those illustrated for data processing system 700. Other components shown in FIG. 7 can be varied from the illustrative examples shown. The different embodiments may be implemented using any hardware device or system capable of running program code 718.

As used herein, the phrase “a number” means one or more. The phrase “at least one of”, when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item C. This example also may include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks may be implemented as program code.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component may be configured to perform the action or operation described. For example, the component may have a configuration or design for a structure that provides the component an ability to perform the action or operation that is described in the illustrative examples as being performed by the component. Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A computer-implement method for training a neural network to detect defects, the method comprising:
using a number of processors to perform the steps of:
encoding, by an encoder, a real image of an object to produce a first compressed image as a first vector in a latent space, wherein the real image is free of defects;
generating, by a decoder, a reconstructed image from the first vector in the latent space, wherein the reconstructed image is a closest non-anomalous reconstruction of the real image;
comparing, by a discriminator, the real image and the reconstructed image;
determining, by the discriminator, which image is the real image and which image is the reconstructed image; and
encoding, by the encoder, the reconstructed image to produce a second compressed image as a second vector in the latent space.

2. The method of claim 1, further comprising back propagating a loss function from the discriminator to the decoder and the encoder.

3. The method of claim 2, wherein the loss function comprises:
a first weighted loss term comprising a mean square error between the real image and the reconstructed image;
a second weighted loss term comprising a mean square error between the first vector and the second vector in the latent space;
a third weighted loss term comprising a discriminative loss for the real image; and
a fourth weighted loss term comprising a discriminative loss for the reconstructed image.

4. The method of claim 3, wherein:
the first weighted loss term informs the decoder, then the encoder;
the second weighted loss term informs the encoder, then the decoder, then the encoder again;
the third weighted loss function informs the discriminator; and
the fourth weighted loss function informs the discriminator, then the decoder, and then the encoder.

5. The method of claim 2, wherein the neural network is trained with a single forward pass and a single backpropagation pass.

6. The method of claim 1, wherein the real input image comprises a three-dimensional image.

7. The method of claim 1, wherein the real input comprises a two-dimensional image.

8. The method of claim 1, wherein the encoder, decoder, and discriminator comprise a generative adversarial network.

9. The method of claim 8, wherein the generative adversarial network comprises a fully convolutional neural network.

10. The method of claim 8, wherein the generative adversarial network comprises a fully connected layer at a narrowest point of the network.

11. The method of claim 1, wherein the real image is an x-ray computed tomography image.

12. A system for training a neural network to detect defects, the system comprising:
a storage device configured to store program instructions; and
one or more processors operably connected to the storage device and configured to execute the program instructions to cause the system to:
encode, by an encoder, a real image of an object to produce a first compressed image as a first vector in a latent space, wherein the real image is free of defects;
generate, by a decoder, a reconstructed image from the first vector in the latent space, wherein the reconstructed image is a closest non-anomalous reconstruction of the real image;
compare, by a discriminator, the real image and the reconstructed image;
determining, by the discriminator, which image is the real image and which image is the reconstructed image; and
encode, by the encoder, the reconstructed image to produce a second compressed image as a second vector in the latent space.

13. The system of claim 12, further comprising back propagating a loss function from the discriminator to the decoder and the encoder.

14. The system of claim 13, wherein the loss function comprises:
a first weighted loss term comprising a mean square error between the real image and the reconstructed image;
a second weighted loss term comprising a mean square error between the first vector and the second vector in the latent space;
a third weighted loss term comprising a discriminative loss for the real image; and
a fourth weighted loss term comprising a discriminative loss for the reconstructed image.

15. The system of claim 14, wherein:
the first weighted loss term informs the decoder, then the encoder;
the second weighted loss term informs the encoder, then the decoder, then the encoder again;
the third weighted loss function informs the discriminator; and
the fourth weighted loss function informs the discriminator, then the decoder, and then the encoder.

16. The system of claim 13, wherein the neural network is trained with a single forward pass and a single backpropagation pass.

17. The system of claim 12, wherein the real input image comprises a three-dimensional image.

18. The system of claim 12, wherein the real input comprises a two-dimensional image.

19. The system of claim 12, wherein the encoder, decoder, and discriminator comprise a generative adversarial network.

20. The system of claim 19, wherein the generative adversarial network comprises a fully convolutional neural network.

21. The system of claim 19, wherein the generative adversarial network comprises a fully connected layer at a narrowest point of the network.

22. The system of claim 12, wherein the real image is an x-ray computed tomography image.
